(19) United States
(12) Patent Application Publication
(10) Pub. No.: US 2016/0116597 A1
(43) Pub. Date: Apr. 28, 2016

(54) APPARATUS FOR RECEIVING NAVIGATION SIGNAL AND OPERATING METHOD OF THE SAME

(71) Applicant: Electronics and Telecommunications Research Institute, Daejeon (KR)

(72) Inventors: Seong Kyun JEONG, Suwon-si Gyeonggi-do (KR); Jae Hoon KIM, Daejeon (KR); Cheon Sig SIN, Daejeon (KR)

(21) Appl. No.: 14/918,878

(22) Filed: Oct. 21, 2015

(30) Foreign Application Priority Data
Oct. 23, 2014 (KR) 10-2014-0144101
Sep. 21, 2015 (KR) 10-2015-0133298

(51) Int. Cl. G01S 19/21; G01S 19/24

(52) U.S. Cl. CPC G01S 19/21; G01S 19/24

(57) ABSTRACT

The present invention provides a navigation signal receiving apparatus, including: a first navigation information generating unit which receives at least one navigation signal; and a second navigation information generating unit which receives the at least one navigation signal, compares reference information generated based on a first navigation signal with measurement information generated based on the at least one navigation signal to determine whether the at least one navigation signal includes a second navigation signal, estimates normal measurement information using the reference information when the at least one navigation signal includes the second navigation signal, and controls the first navigation information generating unit to trace the first navigation signal which is included in the at least one navigation signal based on the normal measurement information.

### CROSS-REFERENCE TO RELATED APPLICATIONS

This application claims priority to and the benefit of Korean Patent Application No. 10-2014-0144101 filed in the Korean Intellectual Property Office on Oct. 23, 2014 and No. 10-2015-0133298 filed in the Korean Intellectual Property Office on Sep. 21, 2015 the entire contents of which are incorporated herein by reference.

### TECHNICAL FIELD

The present invention relates to a navigation signal receiving apparatus and an operating method thereof.

### BACKGROUND ART

As a satellite navigation system is variously used, disturbance or interference of a satellite navigation signal is frequently generated. Disturbance of the satellite navigation system is generally caused by a deceptive attack that causes a satellite navigation receiver to purposely calculate a wrong position and time using a signal which is similar to the satellite navigation signal and a jamming attack which generates a jamming signal in a satellite navigation signal band to cause the receiver to abnormally operate. Specifically, in the case of the deceptive attack, the receiver calculates the position and the time even after the disturbance is generated, so that when information of the receiver is used as it is, a serious damage may be caused.

As a method of responding to the deceptive attack, methods of monitoring and detecting an error sign generated in the receiver or detecting an error of the receiver using a sensor, and switching a deceptive signal have been suggested. However, such methods switch all available navigation signals when the deceptive attack is performed on all the signals, so that the satellite navigation signal cannot be used and normal navigation information cannot be generated.

### SUMMARY OF THE INVENTION

The present invention has been made in an effort to provide a navigation signal receiving apparatus which, even when a deceptive attack is generated, tracks a normal navigation signal to generate navigation information and an operating method thereof.

Technical objects of the present invention are not limited to the aforementioned technical objects and other technical objects which are not mentioned will be apparently appreciated by those skilled in the art from the following description.

An exemplary embodiment of the present invention provides a navigation signal receiving apparatus, including: a first navigation information generating unit which receives at least one navigation signal; and a second navigation information generating unit which receives the at least one navigation signal, compares reference information generated based on a first navigation signal with measurement information generated based on the at least one navigation signal to determine whether the at least one navigation signal includes a second navigation signal, estimates normal measurement information using the reference information when the at least one navigation signal includes the second navigation signal, and controls the first navigation information generating unit to trace the first navigation signal which is included in the at least one navigation signal based on the normal measurement information.

According to an exemplary embodiment, the second navigation information generating unit may include: a signal processing unit which processes the at least one navigation signal to generate the reference information or the measurement information; a determining unit which compares the reference information with the measurement information to determine whether the at least one navigation signal includes the second navigation signal; an estimating unit which estimates the normal measurement information using the reference information when the at least one navigation signal includes the second navigation signal; and a control unit which controls the first navigation information generating unit to trace the first navigation signal included in the at least one navigation signal based on the normal measurement information.

According to an exemplary embodiment, the second navigation information generating unit may further include a storing unit which stores the reference information and the measurement information.

According to an exemplary embodiment, the first navigation signal may be a normal navigation signal and the second navigation signal may be a deceptive signal for the first navigation signal.

According to an exemplary embodiment, the reference information and the measurement information may include at least one of a navigation message, Doppler information, and code information.

According to an exemplary embodiment, the reference information may be generated by the first navigation information generating unit based on the first navigation signal before a time when the second navigation signal is included in the at least one navigation signal.

According to an exemplary embodiment, the reference information may be generated by the second navigation information generating unit based on the first navigation signal before a time when the second navigation signal is included in the at least one navigation signal.

According to an exemplary embodiment, the normal measurement information may be measurement information generated based on the first navigation signal at a reference time.

According to an exemplary embodiment, the reference time may be an arbitrary time after the time when the second navigation signal is included in the at least one navigation signal.

According to an exemplary embodiment, the first navigation signal may be synchronized with the second navigation signal.

According to an exemplary embodiment, a strength of the second navigation signal may be higher than a strength of the first navigation signal.

Another exemplary embodiment of the present invention, an operating method of a navigation signal receiving apparatus, including: receiving at least one navigation signal; comparing reference information generated based on a first navigation signal with measurement information generated based on the at least one navigation signal to determine whether the at least one navigation signal includes a second navigation signal; estimating the normal measurement information using the reference information when the at least one navigation signal includes the second navigation signal; controlling to trace the first navigation signal which is included in the at least one navigation signal based on the normal measurement information; and generating navigation information using the first navigation signal.

According to an exemplary embodiment, the reference information may be generated based on the first navigation signal before a time when the second navigation signal is included in the at least one navigation signal.

According to an exemplary embodiment, the normal measurement information may be measurement information generated based on the first navigation signal at a reference time.

According to an exemplary embodiment, the reference time may be an arbitrary time after the time when the second navigation signal is included in the at least one navigation signal.

According to an exemplary embodiment, the first navigation signal may be a normal navigation signal and the second navigation signal may be a deceptive signal for the first navigation signal.

According to a navigation signal receiving apparatus according to an exemplary embodiment of the present invention and an operating method thereof, even when a deceptive attack is generated, it is possible to track a normal navigation signal to generate navigation information.

### BRIEF DESCRIPTION OF THE DRAWINGS

FIG. 1 is a block diagram of a navigation signal receiving apparatus according to an exemplary embodiment of the present invention.

FIG. 2 is a block diagram of a second navigation information generating unit of a navigation signal receiving apparatus according to an exemplary embodiment of the present invention.

FIGS. 3A to 3C are views illustrating an operation of a determining unit of a second navigation information generating unit of a navigation signal receiving apparatus according to an exemplary embodiment of the present invention.

FIG. 4 is a flowchart of an operating method of a navigation signal receiving apparatus according to an exemplary embodiment of the present invention.

FIG. 5 is a block diagram illustrating a computing system which executes an operating method of a navigation signal receiving apparatus according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Hereinafter, some embodiments of the present invention will be described in detail with reference to the exemplary accompanying drawings. In the figures, even though the parts are illustrated in different drawings, it should be understood that like reference numerals refer to the same parts of the present invention. In describing the embodiments of the present invention, when it is determined that the detailed description of the known configuration or function related to the present invention may obscure the understanding of embodiments of the present invention, the detailed description thereof will be omitted.

In describing components of the exemplary embodiment of the present invention, terminologies such as first, second, A, B, (a), (b), and the like may be used. However, such terminologies are used only to distinguish a component from another component but nature or an order of the component is not limited by the terminologies. If it is not contrarily defined, all terms used herein including technological or scientific terms have the same meaning as those generally understood by a person with ordinary skill in the art. Terms which are defined in a generally used dictionary should be interpreted to have the same meaning as the meaning in the context of the related art but are not interpreted as an ideally or excessively formal meaning if they are not clearly defined in the present invention.

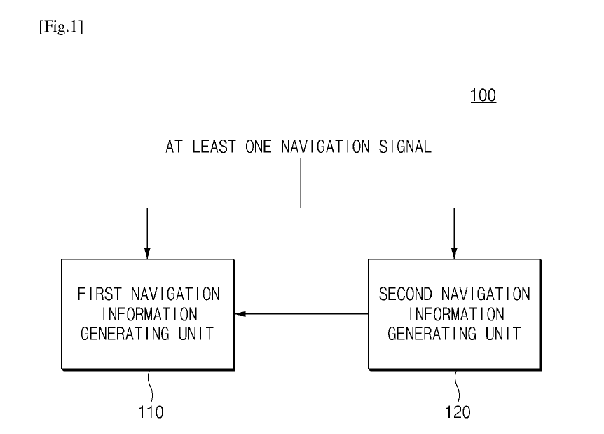

FIG. 1 is a block diagram of a navigation signal receiving apparatus according to an exemplary embodiment of the present invention.

Referring to FIG. 1, a navigation signal receiving apparatus 100 according to an exemplary embodiment of the present invention may include a first navigation information generating unit 110 and a second navigation information generating unit 120.

The first navigation information generating unit 110 may receive at least one navigation signal. For example, the at least one navigation signal may include only a first navigation signal or a first navigation signal and a second navigation signal. Here, the first navigation signal may refer to a normal navigation signal and the second navigation signal may refer to a deceptive signal for the first navigation signal. For example, the first navigation signal and the second navigation signal may be synchronized signals, but are not limited thereto. For example, a strength of the second navigation signal may be higher than a strength of the first navigation signal, but is not limited thereto.

The first navigation information generating unit 110 may generate measurement information using at least one received navigation signal. The first navigation information generating unit 110 may generate navigation information using the measurement information. For example, the navigation information may include position information and time information of the navigation signal receiving apparatus 100.

When the at least one received navigation signal includes only the first navigation signal, the first navigation information generating unit 110 may generate normal navigation information and when the at least one received navigation signal includes the first navigation signal and the second navigation signal, may generate navigation information (that is, erroneous navigation information) having an error caused by deception.

As described above, when the at least one received navigation signal includes the first navigation signal and the second navigation signal, the first navigation information generating unit 110 may control the first navigation information generating unit 110 to generate normal navigation information.

The second navigation information generating unit 120 may receive at least one navigation signal. The at least one navigation signal which is received by the second navigation information generating unit 120 may be equal to the at least one navigation signal which is received by the first navigation information generating unit 110.

The second navigation information generating unit 120 may generate measurement information using at least one received navigation signal.

The second navigation information generating unit 120 compares the generated measurement information with reference information to determine whether the at least one navigation signal includes the second navigation signal. For example, the reference information may refer to measurement information which is generated based on the first navigation signal which is a normal navigation signal. For example, when the measurement information is different from the reference information, the second navigation information generating unit 120 may determine that the at least one navigation signal includes the second navigation signal. For example, the reference information and the measurement information may include at least one of a navigation message, Doppler information, code information, and time information. The navigation message may include a visible value of a satellite and a satellite orbit value.

When it is determined that the at least one navigation signal includes the second navigation signal, the second navigation information generating unit 120 may estimate normal measurement information using the reference information. For example, the normal measurement information may refer to measurement information which is generated based on the first navigation signal at a target time and the target time may refer to an arbitrary time after deception is generated (that is, after a time when the second navigation signal is included in the at least one navigation signal).

The second navigation information generating unit 120 may control the first navigation information generating unit 110 to track the first navigation signal which is included in the at least one navigation signal based on the normal measurement information. For example, the second navigation information generating unit 120 may generate control information which controls the first navigation information generating unit 110 to trace the first navigation signal which is included in the at least one navigation signal based on the normal measurement information. The control information may include information for controlling a signal tracing parameter of the first navigation information generating unit 110. By doing this, the first navigation information generating unit 110 traces the first navigation signal to generate the reference information and generates the normal navigation information using the generated reference information.

As described above, when deception is generated (that is, the at least one received navigation signal includes a second navigation signal), the second navigation information generating unit 120 of the navigation signal receiving apparatus 100 according to the exemplary embodiment of the present invention may control the first navigation information generating unit 110 to trace the first navigation signal to generate the normal navigation signal.

Hereinafter, the above-described second navigation information generating unit 120 will be described in more detail.

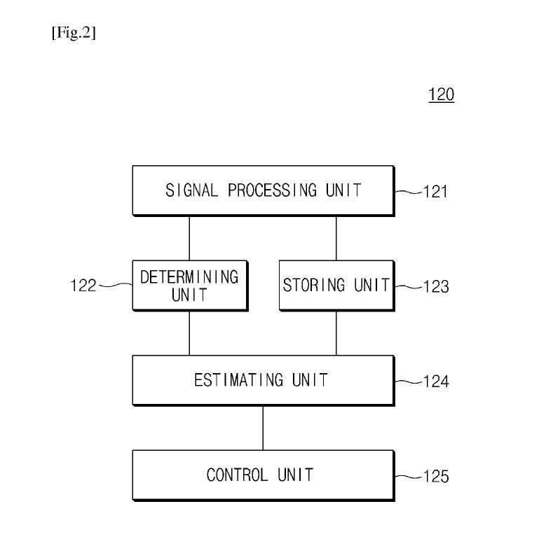

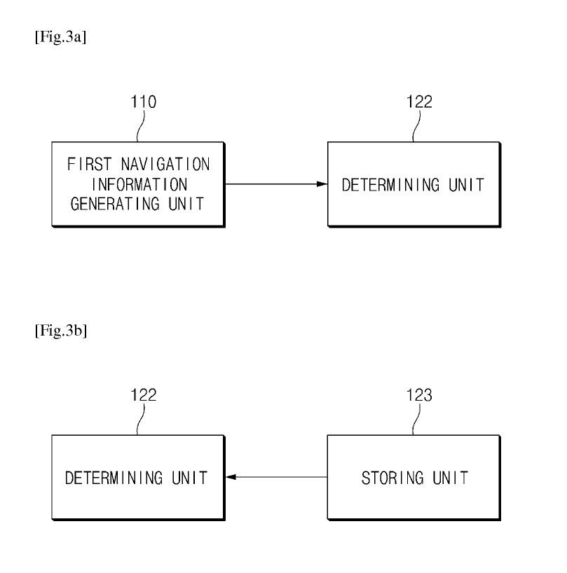

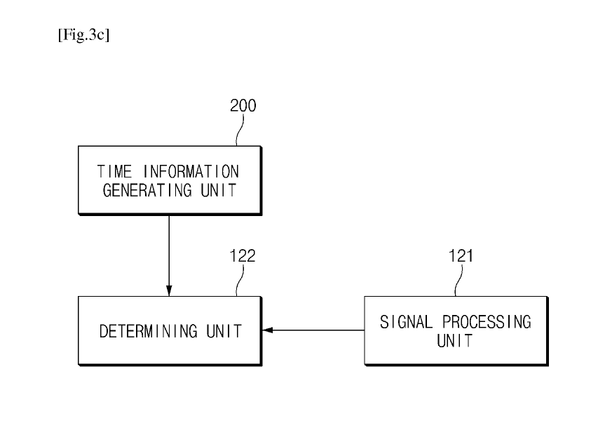

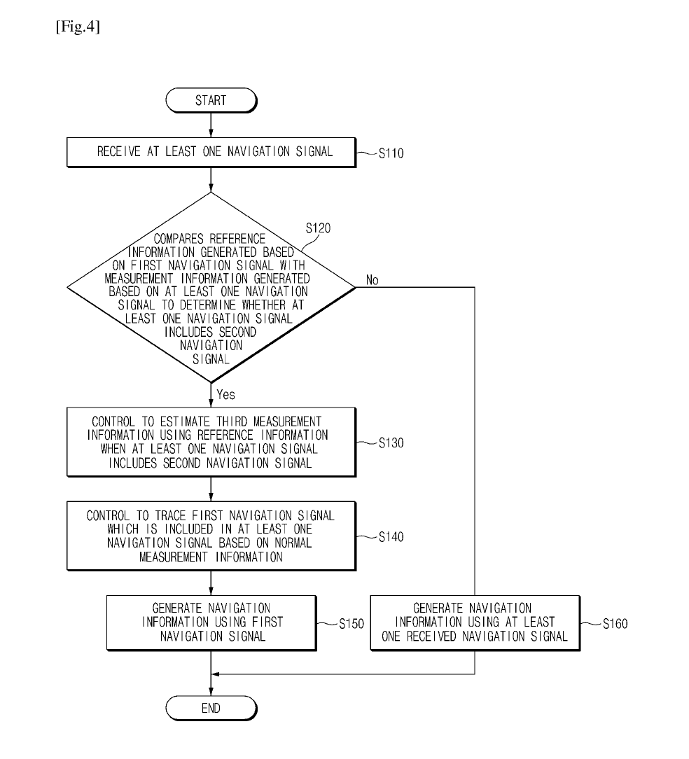

FIG. 2 is a block diagram of a second navigation information generating unit of a navigation signal receiving apparatus according to an exemplary embodiment of the present invention. FIGS. 3A to 3C are views illustrating an operation of a determining unit of a second navigation information generating unit of a navigation signal receiving apparatus according to an exemplary embodiment of the present invention.

First, referring to FIG. 2, the second navigation signal generating unit 120 according to an exemplary embodiment of the present invention may include a signal processing unit 121, a determining unit 122, a storing unit 123, an estimating unit 124, and a control unit 125.

The signal processing unit 121 processes at least one received navigation signal to generate measurement information. The signal processing unit 121 may generate the navigation information using the generated measurement information.

The determining unit 122 compares reference information with the measurement information to determine whether at least one navigation signal includes a second navigation signal. For example, the reference information may refer to measurement information which is generated based on the first navigation signal which is a normal navigation signal and may include measurement information which is generated by the signal processing unit 121 before deception is generated.

When the measurement information is different from the reference information, the determining unit 122 may determine that at least one navigation signal includes a second navigation signal. Since the measurement information generated from the signal processing unit 121 is equal to the reference information before deception is generated, the determining unit 122 may determine that the at least one navigation signal does not include the second navigation signal.

A specific determining process of the determining unit 122 will be described in more detail with reference to FIGS. 3A to 3C.

Referring to FIG. 3A, the determining unit 122 compares the reference information which is transmitted from the first navigation information generating unit 110 (see FIG. 1) with the measurement information which is transmitted from the signal processing unit 121 (see FIG. 2) to determine whether at least one navigation signal includes the second navigation signal.

That is, when deception is generated at a first time, the determining unit 122 compares reference information which is generated by the first navigation information generating unit 110 immediately before deception is generated with the measurement information to determine whether at least one navigation signal includes the second navigation signal.

Even though at least one navigation signal includes the first navigation signal and the second navigation signal, when the first navigation information generating unit 110 is controlled by the second navigation information generating unit 120 to trace only the first navigation signal to generate reference information, the determining unit 122 compares the reference information which is transmitted from the first navigation information generating unit 110 with the measurement information to determine whether at least one navigation signal includes the second navigation signal.

Referring to FIG. 3B, the determining unit 122 compares the reference information which is transmitted from the storing unit 123 with the measurement information which is transmitted from the signal processing unit 121 (see FIG. 2) to determine whether at least one navigation signal includes the second navigation signal.

That is, when deception is generated at a first time, the determining unit 122 compares reference information, which is generated by the signal processing unit 121 of the second navigation information generating unit 120 immediately before deception is generated to be stored in the storing unit 123, with the measurement information to determine whether at least one navigation signal includes the second navigation signal.

Referring to FIG. 3C, the time information generating unit 200 may generate time information using the navigation information of the first navigation information generating unit 110. For example, time information which is generated by the time information generating unit 200 may be time information which is generated when the normal navigation signal is received. The time information generating unit 200 may be included in the navigation signal receiving apparatus 100.

The determining unit 122 compares the time information which is transmitted from the time information generating unit 200 with time information included in the measurement signal which is generated by the signal processing unit 121 to determine whether at least one navigation signal includes the second navigation signal and/or flowing of the second navigation signal ends.

Referring to FIG. 2 again, the storing unit 123 may store the measurement information which is generated by the signal processing unit 121.

When it is determined that the at least one navigation signal includes the second navigation signal, the estimating unit 124 may estimate normal measurement information using the reference information. For example, the normal measurement information may refer to measurement information which is generated based on the first navigation signal at a target time and the target time may refer to an arbitrary time after deception is generated (that is, after a time when the second navigation signal is included in the at least one navigation signal). For example, the estimating unit 124 assumes change of measurement information as a quadratic function and estimates coefficients of the quadratic function by the least square method using the measurement information which was measured at the past time and then estimates the normal measurement information using the assumed quadratic function.

The control unit 125 may control the first navigation information generating unit 110 to trace the first navigation signal which is included in at least one navigation signal based on the normal measurement information. For example, the control unit 125 may generate control information which controls the first navigation information generating unit 110 to trace the first navigation signal which is included in the at least one navigation signal based on the normal measurement information. The control information may include information for controlling a signal tracing parameter of the first navigation information generating unit 110. By doing this, the first navigation information generating unit 110 traces the first navigation signal to generate the reference information and generates the normal navigation information using the generated reference information.

FIG. 4 is a flowchart of an operating method of a navigation signal receiving apparatus according to an exemplary embodiment of the present invention.

Referring to FIG. 4, an operating method of a navigation signal receiving apparatus according to an exemplary embodiment of the present invention includes receiving at least one navigation signal in step S110, comparing reference information generated based on a first navigation signal with measurement information generated based on at least one navigation signal to determine whether at least one navigation signal includes a second navigation signal in step S120, estimating normal measurement information using the reference information when the at least one navigation signal includes the second navigation signal in step S130, controlling to trace the first navigation signal which is included in the at least one navigation signal based on the normal measurement information in step S140, generating navigation information using the first navigation signal in step S150, and generating the navigation information using at least one received navigation signal in step S160.

Hereinafter, steps S110 to S160 will be described in more detail with reference to FIGS. 1 and 2.

In step S110, the second navigation information generating unit 120 may receive at least one navigation signal. The at least one navigation signal which is received by the second navigation information generating unit 120 may be the same as the at least one navigation signal which is received by the first navigation information generating unit 120.

In step S120, the second navigation information generating unit 120 compares the reference information generated based on the first navigation signal with the measurement information generated based on at least one navigation signal to determine whether at least one navigation signal includes the second navigation signal.

For example, the determining unit 122 compares reference information with the measurement information to determine whether at least one navigation signal includes a second navigation signal. When the measurement information is different from the reference information, the determining unit 122 may determine that at least one navigation signal includes a second navigation signal. Since the measurement information generated from the signal processing unit 121 is equal to the reference information before deception is generated, the determining unit 122 may determine that the at least one navigation signal does not include the second navigation signal.

In step S130, the second navigation information generating unit 120 may estimate normal measurement information using the reference information. For example, the normal measurement information may refer to measurement information which is generated based on the first navigation signal at a target time and the target time may refer to an arbitrary time after deception is generated (that is, after a time when the second navigation signal is included in the at least one navigation signal). For example, the estimating unit 124 may estimate the normal measurement information using the reference information.

In step S140, the second navigation information generating unit 120 may control the first navigation information generating unit 110 to track the first navigation signal which is included in the at least one navigation signal based on the normal measurement information. For example, the second navigation information generating unit 120 may generate control information which controls the first navigation information generating unit 110 to track the first navigation signal which is included in the at least one navigation signal based on the normal measurement information. The control information may include information for controlling a signal tracing parameter of the first navigation information generating unit 110. For example, the control unit 125 may control the first navigation information generating unit 110 to trace the first navigation signal which is included in at least one navigation signal based on the normal measurement information.

In step S150, the first navigation information generating unit 110 traces the first navigation signal to generate the reference information and generates the normal navigation information using the generated reference information.

In the meantime, when it is determined that at least one navigation signal does not include the second navigation signal in step S120, the first navigation information generating unit 110 may generate navigation information using at least one received navigation signal.

As described above, when deception is generated (that is, the at least one received navigation signal includes a second navigation signal), the operating method of a navigation signal receiving apparatus according to the exemplary embodiment of the present invention may control to trace the first navigation signal to generate the normal navigation information.

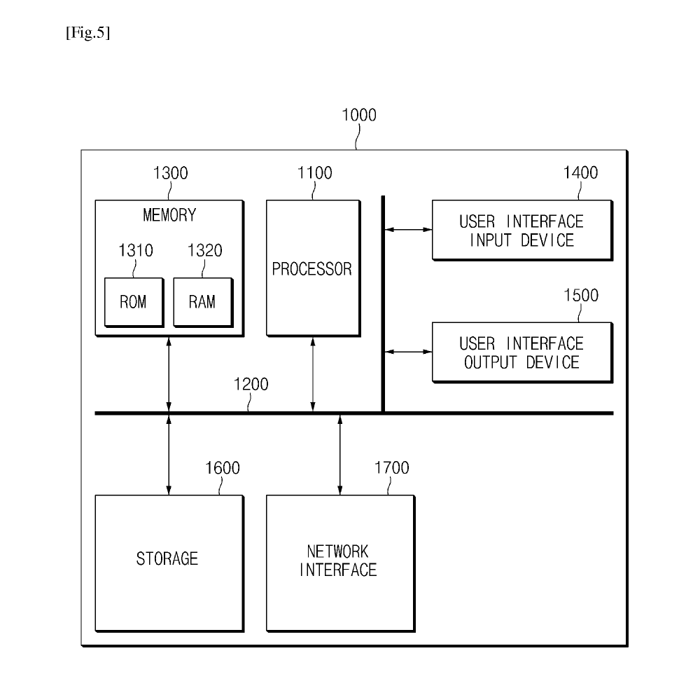

FIG. 5 is a block diagram illustrating a computing system which executes an operating method of a navigation signal receiving apparatus according to an exemplary embodiment of the present invention.

Referring to FIG. 5, a computing system 1000 may include at least one processor 1100, a memory 1300, a user interface input device 1400, a user interface output device 1500, a storage 1600, and a network interface 1700 which are connected to each other through a system bus 1200.

The processor 1100 may be a semiconductor device which performs processings on commands which are stored in a central processing unit (CPU), or the memory 1300 and/or the storage 1600. The memory 1300 and the storage 1600 may include various types of volatile or non-volatile storage media. For example, the memory 1300 may include a read only memory (ROM) and a random access memory (RAM).

The method or a step of algorithm which has been described regarding the exemplary embodiments disclosed in the specification may be directly implemented by hardware or a software module which is executed by a processor 1100 or a combination thereof. The software module may be stored in a storage medium (that is, the memory 1300 and/or the storage 1600) such as a RAM, a flash memory, a ROM, an EPROM, an EEPROM, a register, a hard disk, a detachable disk, or a CD-ROM. An exemplary storage medium is coupled to the processor 1100 and the processor 1100 may read information from the storage medium and write information in the storage medium. As another method, the storage medium may be integrated with the processor 1100. The processor and the storage medium may be stayed in an application specific integrated circuit (ASIC). The ASIC may be stayed in a user terminal. As another method, the processor and the storage medium may be stayed in a user terminal as individual components.

It will be appreciated that various exemplary embodiments of the present invention have been described herein for purposes of illustration of a technical spirit of the present invention, and that various modifications, changes, and substitutions may be made by those skilled in the art without departing from the scope and spirit of the present invention.

Accordingly, the exemplary embodiments disclosed herein are intended to not limit but describe the technical spirit of the present invention and the scope of the technical spirit of the present invention is not restricted by the exemplary embodiments. The protection scope of the present invention should be interpreted based on the following appended claims and it should be appreciated that all technical spirits included within a range equivalent thereto are included in the protection scope of the present invention.

What is claimed is:

1. A navigation signal receiving apparatus, comprising:
a first navigation information generating unit which receives at least one navigation signal; and
a second navigation information generating unit which receives the at least one navigation signal, compares reference information generated based on a first navigation signal with measurement information generated based on the at least one navigation signal to determine whether the at least one navigation signal comprises a second navigation signal, estimates normal measurement information using the reference information when the at least one navigation signal includes the second navigation signal, and controls the first navigation information generating unit to trace the first navigation signal which is included in the at least one navigation signal based on the normal measurement information.

2. The navigation signal receiving apparatus of claim 1, wherein the second navigation information generating unit comprises:
a signal processing unit which processes the at least one navigation signal to generate the reference information or the measurement information;
a determining unit which compares the reference information with the measurement information to determine whether the at least one navigation signal comprises the second navigation signal;
an estimating unit which estimates the normal measurement information using the reference information when the at least one navigation signal comprises the second navigation signal; and
a control unit which controls the first navigation information generating unit to trace the first navigation signal included in the at least one navigation signal based on the normal measurement information.

3. The navigation signal receiving apparatus of claim 2, wherein the second navigation information generating unit further comprises a storing unit which stores the reference information and the measurement information.

4. The navigation signal receiving apparatus of claim 1, wherein the first navigation signal is a normal navigation signal and the second navigation signal is a deceptive signal for the first navigation signal.

5. The navigation signal receiving apparatus of claim 1, wherein the reference information and the measurement information comprise at least one of a navigation message, Doppler information, and code information.

6. The navigation signal receiving apparatus of claim 1, wherein the reference information is generated by the first navigation information generating unit based on the first navigation signal before a time when the second navigation signal is included in the at least one navigation signal.

7. The navigation signal receiving apparatus of claim 1, wherein the reference information is generated by the second navigation information generating unit based on the first navigation signal before a time when the second navigation signal is included in the at least one navigation signal.

8. The navigation signal receiving apparatus of claim 1, wherein the normal measurement information is measurement information generated based on the first navigation signal at a target time.

9. The navigation signal receiving apparatus of claim 8, wherein the target time is an arbitrary time after the time when the second navigation signal is included in the at least one navigation signal.

10. The navigation signal receiving apparatus of claim 1, wherein the first navigation signal is synchronized with the second navigation signal.

11. The navigation signal receiving apparatus of claim 1, wherein a strength of the second navigation signal is higher than a strength of the first second navigation signal.

12. An operating method of a navigation signal receiving apparatus, comprising:
receiving at least one navigation signal;
comparing reference information generated based on a first navigation signal with measurement information generated based on the at least one navigation signal to determine whether at least one navigation signal comprises a second navigation signal;
estimating the normal measurement information using the reference information when the at least one navigation signal comprises the second navigation signal;
controlling to trace the first navigation signal which is included in the at least one navigation signal based on the normal measurement information; and
generating navigation information using the first navigation signal.

13. The operating method of claim 12, wherein the reference information is generated based on the first navigation signal before a time when the second navigation signal is included in the at least one navigation signal.

14. The operating method of claim 12, wherein the normal measurement information is measurement information generated based on the first navigation signal at a target time.

15. The operating method of claim 14, wherein the target time is an arbitrary time after the time when the second navigation signal is included in the at least one navigation signal.

16. The operating method of claim 12, wherein the first navigation signal is a normal navigation signal and the second navigation signal is a deceptive signal for the first navigation signal.
